(19) United States
(12) Patent Application Publication
(10) Pub. No.: US 2026/0197159 A1
(43) Pub. Date: Jul. 9, 2026

(54) QUANTUM SECURITY METHOD AND QUANTUM SECURITY SYSTEM

(71) Applicant: NATIONAL CHIN-YI UNIVERSITY OF TECHNOLOGY, Taichung (TW)

(72) Inventor: Chi-Tung CHEN, Taichung (TW)

(21) Appl. No.: 19/079,483

(22) Filed: Mar. 14, 2025

(30) Foreign Application Priority Data
Jan. 3, 2025 (TW) 114100240

(51) Int. Cl. H04L 9/08; H04L 9/06; H04L 9/32

(52) U.S. Cl. CPC H04L 9/0852; H04L 9/0643; H04L 9/3236

(57) ABSTRACT

A quantum security method, including: determining a session key; utilizing a hash function to process the session key to obtain a first string; combining the first string, a second string and a third string into a combined string; transmitting the combined string through at least one basis to generate a first single photon sequence, and transmitting the first single photon sequence to the receiver through a quantum channel; receiving the first single photon sequence and measuring the first string and the second string through the at least one basis to obtain a first return string and a second return string respectively, and transmitting a second single photon sequence; verifying the first return string, the second return string and a third return string sequentially to obtain a first verification result; and utilizing the hash function to verify the session key to obtain a second verification result.

### RELATED APPLICATIONS

This application claims priority to Taiwan Application Serial Number 114100240, filed on January 3, 2025, which is herein incorporated by reference.

### BACKGROUND

### Technical Field

The present disclosure relates to a security method and a security system, and more particularly to a quantum security method and a quantum security system.

### Description of Related Art

Photon is a kind of electromagnetic wave, and the polarization direction of the photon is the vibration direction of the electric field where the photon is moving. A polarizer may be utilized to measure the polarization direction of photons, which allows photons with polarization directions parallel to the slit to pass through, but filters out all photons perpendicular to the slit. If utilizing a vertically oriented polarizer to observe a X-basis photon (the polarization direction is only 45° or -45°), there is a 50% chance of observing the photon, but there is also a 50% chance of not being able to observe the photon. Furthermore, this photon may be thought as a vertically polarized photon while observing it, but in fact, this photon is a 45° polarized photon. In this way, the original state of this observed photon has been destroyed, which means that this photon is no longer a 45° polarized photon, but has become a vertically polarized photon.

It can be seen from the above examples that quantum has the characteristic of superposition state. Due to this characteristic, if the basis of the photon polarization is unknown, the photon may not be measured correctly. Of course, the correct initial state of the photon may not be known. The superposition properties of quantum are often used to design secure quantum communications, also known as quantum cryptography.

### SUMMARY

The object of the present disclosure is to provide a quantum security method and a quantum security system to resist collective attacks, reflecting attacks and impersonation attacks that may be encountered in the process of quantum communication by the implementation of selecting a basis for a sender to generate photons, selecting a basis for a receiver to measure photons, and mutual verification between the sender and the receiver, so as to achieve secure communication in a semi-quantum communication environment, and have higher transmission efficiency and qubit efficiency compared to other quantum security methods and quantum security systems.

One aspect of the present disclosure relates to a quantum security method, which includes determining a session key by a sender and a receiver jointly; utilizing a hash function to process the session key to obtain a first string by the sender; combining the first string, a second string and a third string into a combined string by the sender; transmitting the combined string through at least one basis to generate a first single photon sequence by the sender, and transmitting the first single photon sequence to the receiver through a quantum channel by the sender; receiving the first single photon sequence and measuring the first string and the second string through the at least one basis to obtain a first return string and a second return string respectively by the receiver, and transmitting a second single photon sequence back to the sender by the receiver; verifying the first return string, the second return string and a third return string sequentially by the sender to obtain a first verification result; and utilizing the hash function to verify the session key to obtain a second verification result by the receiver.

In accordance with one or more embodiments of the present disclosure, the quantum security method further comprises: determining a first pre-shared key, a second pre-shared key and a third pre-shared key jointly by the sender and the receiver, wherein the first pre-shared key and the second pre-shared key are utilized to determine positions of the first string, the second string and the third string in the combined string, and wherein the third pre-shared key is utilized to determine the selected hash function.

In accordance with one or more embodiments of the present disclosure, the at least one basis comprises a first basis and a second basis, and the first basis is a Z-basis, and the second basis is an X-basis.

In accordance with one or more embodiments of the present disclosure, steps of transmitting the combined string through the at least one basis to generate the first single photon sequence by the sender comprises: generating a first single photon through the first basis utilizing the first string; generating a second single photon through the second basis utilizing the second string; and generating a third single photon through the second basis utilizing the third string, wherein the single photon sequence is composed of the first single photon, the second single photon and the third single photon.

In accordance with one or more embodiments of the present disclosure, steps of receiving the first single photon sequence and measuring the first string and the second string through the at least one basis by the receiver comprises: measuring the first single photon of the first string through the first basis; and measuring the second single photon of the second string through the first basis, wherein the receiver does not measure the third single photon of the third string but directly reflects the third single photon back to the sender.

In accordance with one or more embodiments of the present disclosure, the sender verifies the first return string by comparing whether a content of the first return string is the same as a content of the first string, wherein the sender verifies the second return string by comparing whether a content of the second return string is different from a content of the second string, and wherein the sender verifies the third return string by comparing whether a content of the third return string is the same as a content of the third string.

In accordance with one or more embodiments of the present disclosure, the sender obtains the first verification result of the sender verifying the receiver after the sender comparing the content of the first return string is the same as the content of the first string, comparing the content of the second return string is different from the content of the second string, and comparing the content of the third return string is the same as the content of the third string.

In accordance with one or more embodiments of the present disclosure, the receiver obtains the second verification result of the receiver verifying the sender after the receiver verifying the session key utilizing the hash function.

Another aspect of the present disclosure relates to a quantum security system that includes a memory and a processor. The memory is configured to store at least one instruction. The processor is coupled to the memory and configured to execute the at least one instruction to complete a plurality of steps: determining a session key by a sender and a receiver jointly; utilizing a hash function to process the session key to obtain a first string by the sender; combining the first string, a second string and a third string into a combined string by the sender; transmitting the combined string through at least one basis to generate a first single photon sequence by the sender, and transmitting the first single photon sequence to the receiver through a quantum channel by the sender; receiving the first single photon sequence and measuring the first string and the second string through the at least one basis to obtain a first return string and a second return string respectively by the receiver, and transmitting a second single photon sequence back to the sender by the receiver; verifying the first return string, the second return string and a third return string sequentially by the sender to obtain a first verification result; and utilizing the hash function to verify the session key to obtain a second verification result by the receiver.

In accordance with one or more embodiments of the present disclosure, the sender is a quantum user utilizing a quantum device with full quantum capabilities, and the receiver is a traditional user utilizing a traditional device with limited quantum capabilities.

### BRIEF DESCRIPTION OF THE DRAWINGS

This disclosure can be more fully understood by reading the following detailed description of the embodiments, with reference made to the accompanying drawings as follows:

FIG. 1 is a flowchart of a quantum security method in accordance with some embodiments of the present disclosure.

FIG. 2 is a functional block diagram of a quantum security system in accordance with some embodiments of the present disclosure.

### DETAILED DESCRIPTION

Reference will now be made in detail to the present embodiments of this disclosure, examples of which are illustrated in the accompanying drawings. Wherever possible, the same reference numbers are utilized in the drawings and the description to refer to the same or like parts. The verb “couple” and its conjugated forms means to complete any type of required junction, including electrical, mechanical, or fluid, to form a singular object from two or more previously non-joined objects.

Since quantum has the characteristics of superposition state, in the process of quantum communication, once a malicious attacker wants to eavesdrop, such as performing collective attacks, the action of data collection definitely destroys the quantum superposition state. In this way, both parties in the communication may detect the presence of the eavesdropper and avoid continuing to communicate when there is a risk of eavesdropping.

Even though quantum communication has the advantage of resisting eavesdropping by malicious attackers, in order to achieve quantum communication, both communicating parties need to have quantum capabilities. However, quantum devices with full quantum capabilities are expensive to build. Therefore, In general, due to communication cost considerations, one party to quantum communication (such as the sender) may be a quantum user utilizing a quantum device with full quantum capabilities, while the other party to quantum communication (such as the receiver) may be a classical user utilizing a classical device with limited quantum capabilities. In general, the communication environment composed of quantum devices, quantum users, classical devices, and classical users is called a semi-quantum environment.

It should be noted that although the classical device is not required to have full quantum capabilities, it must still have quantum capabilities, including but not limited to, transmitting photons (qubits), measuring photons, and rearranging photons.

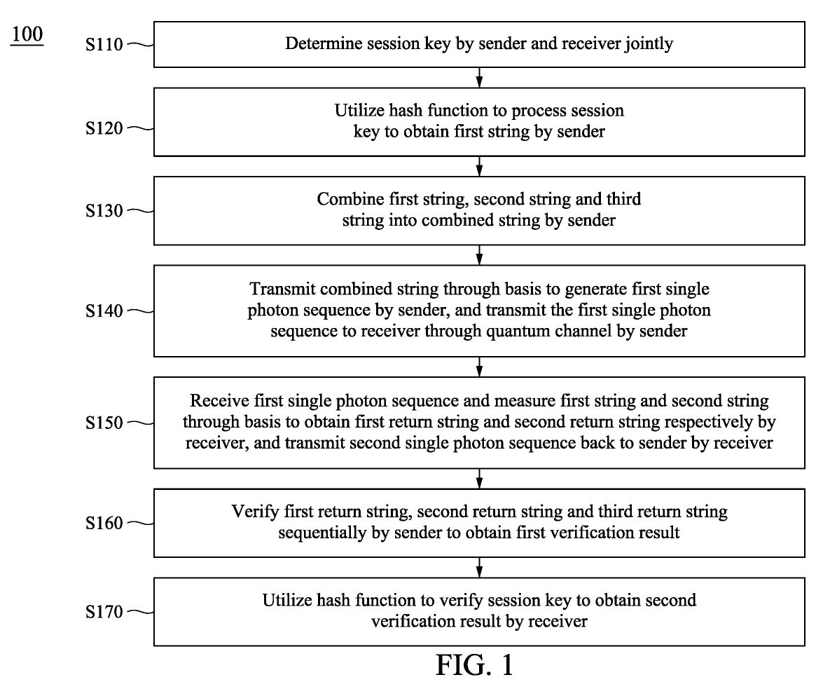

FIG. 1 is a flowchart of a quantum security method 100 in accordance with some embodiments of the present disclosure. The quantum security method 100 includes Steps S110 to S170, which are described below.

Step S110: determine a session key by a sender and a receiver jointly. This step illustrates that the two communicating parties conducting quantum communication must first agree on the session key, which is utilized by the sender to perform encryption and the receiver to perform decryption. Therefore, the first problem that needs to be solved to conduct quantum communication is the transmission of the session key, which is a key distribution problem.

Step S120: utilize a hash function to process the session key to obtain a first string by the sender. This step illustrates that after the session key is determined in Step S110, the sender (such as a quantum user) then processes the session key utilizing the hash function to obtain the first string. In specific, the session key is encrypted into the first string through the hash function, and a malicious attacker cannot decrypt the session key from the first string without knowing the selected hash function.

Step S130: combine the first string, a second string and a third string into a combined string by the sender. This step illustrates that after the session key processed by the hash function in Step S120 to obtain the first string, the second string (different from the first string), and the third string (different from the first string) are combined into the combined string to further enhance the protection of the session key.

It should be noted that the two communicating parties conducting quantum communication must further agree on three pre-shared keys before starting communication, namely a first pre-shared key, a second pre-shared key and a third pre-shared key, respectively.

The first pre-shared key and the second pre-shared key are utilized to determine the positions of the first string, the second string and the third string in the combined string. For example, when the value of the first pre-shared key is 1, it indicates the position of the first string in the combined string. On the contrary, when the value of the first pre-shared key is 0, it indicates that the position in the combined string does not belong to the first string (the position may belong to the second string or the third string). Then, the second pre-shared key is utilized to determine the position of the second string and the third string. When the value of the second pre-shared key is 1, it indicates the position of the second string in the combined string. On the contrary, when the value of the second pre-shared key is 0, it indicates the position of the third string in the combined string.

The third pre-shared key is utilized to determine the selected hash function. As mentioned above, if the hash function is unknown, the session key cannot be decrypted from the encrypted string. Therefore, the sender and receiver as the communicating parties need to agree on the selected hash function through the third pre-shared key to protect the security of the session key during the transmission process.

Step S140: transmit the combined string through at least one basis to generate a first single photon sequence by the sender, and transmit the first single photon sequence to the receiver through a quantum channel by the sender. This step illustrates that after the first string, the second string and the third string combined into the combined string in Step S130, the sender generates a first single photon sequence utilizing the combined string through at least one basis, and transmits the generated first single photon sequence to the receiver through a quantum channel. The at least one basis utilized therein includes but is not limited to a first basis and a second basis, in which the first basis is a Z-basis and the second basis is an X-basis. It should be noted that when the Z-basis photons are generated, the polarization direction of these Z-basis photons may only be 0° or 90°, and when the X-basis photons are generated, the polarization direction of these X-basis photons may only be 45° or -45°.

In specific, the steps of transmitting the combined string through the at least one basis to generate the first single photon sequence include but are not limited to: transmitting the first string through the first basis to generate a first single photon by the sender; transmitting the second string through the second basis to generate a second single photon by the sender; and transmitting the third string through the second basis to generate a third single photon by the sender. It should be noted that the single photon sequence consists of the first single photon, the second single photon and the third single photon.

Step S150: receive the first single photon sequence and measure the first string and the second string through the at least one basis to obtain a first return string and a second return string respectively by the receiver, and transmit a second single photon sequence back to the sender by the receiver. This step illustrates that after the first single photon sequence transmitted from the sender to the receiver in Step S140, the receiver receives the first single photon sequence and measure the first string and the second string through at least one basis (such as the first basis/Z -basis or the second basis/X-basis) to obtain a first return string and a second return string, respectively, and then returns a second single photon sequence to the sender. In specific, the steps of receiving the first single photon sequence by the receiver and measuring the first string and the second string through the at least one basis include but are not limited to: measuring the first single photon of the first string through the first basis and measuring the second single photon of the second string through the first basis, in which the receiver does not measure the third single photon of the third string but directly reflects the third single photon back to the sender. It is worth mentioning that the sender generates the second single photon utilizing the second string through the second basis (i.e., X-basis), while the receiver measures the generated second single photon through the first basis (i.e., Z-basis). That is, the receiver deliberately utilizes the wrong basis to measure the second single photon, so as to resist the aforementioned collective attacks (i.e. eavesdropping) during quantum communication. Further, receiver deliberately utilizes the wrong basis to measure the second single photon, so as also to resist reflecting attacks during quantum communication. The principle of reflecting attack is that a malicious attacker may deceive the sender by not receiving the first single photon, the second single photon and the third single photon but directly reflecting these photons back to the sender, so as to pass the authentication of the sender. Therefore, the legitimate receiver may defend against reflecting attacks by deliberately utilizing the wrong basis to measure single photons. In this way, as long as the sender finds that the second string sent out is actually the same as the second return string returned by the receiver, it can be detected that a malicious attacker performs reflecting attacks during the communication process.

Step S160: verify the first return string, the second return string and a third return string sequentially by the sender to obtain a first verification result. This step illustrates that after returning the second single photon sequence to the sender from the receiver in Step S150, the sender may sequentially verify the first return string, the second return string and the third return string to obtain a first verification result. In specific, the sender verifies the first return string by comparing whether a content of the first return string is the same as a content of the first string. Due to the second single photon is measured utilizing the wrong basis intentionally to defend against reflecting attacks, the sender verifies the second return string by comparing whether a content of the second return string is "not" the same as a content of the second string. The third single photon is not received and measured by the receiver, but is directly reflected back to the sender while maintaining the quantum superposition state. Therefore, the sender verifies the third return string by comparing whether a content of the third return string is the same as a content of the third string.

In one embodiment of the present disclosure, when the sender finds that the content of the first return string is the same as the content of the first string, the content of the second return string is "not" the same as the content of the second string and the content of the third return string is the same as the content of the third string, it indicates that the sender completes the verification of the receiver, that is, the first verification result is obtained that the sender verifies the receiver. On the contrary, if only one of the three groups of string content comparisons fails, the first verification result is obtained that the sender fails to verify the receiver.

Step S170: utilize the hash function to verify the session key to obtain a second verification result by the receiver. This step illustrates that the sender may verify whether the receiver is a legitimate receiver in Step S160, and the receiver may also verify whether the sender is a legitimate sender by processing the session key utilizing the hash function. For example, the receiver may utilize the hash function determined by the third pre-shared key to process the session key received from the sender. If the string processed by the hash function is the same as the first string, it means that the sender of the session key is the same person and not a malicious attacker. In this way, the receiver completes the verification of the sender, and the second verification result is obtained that the receiver verifies the sender. It should be noted that after the two communicating parties complete mutual authentication through Step S160 and Step S170, both the two communicating parties are capable of resisting impersonation attacks by malicious attackers.

It is worth mentioning that the quantum security method 100 of the present disclosure has higher transmission efficiency than other existing quantum security methods, where the transmission efficiency is defined as the number of photons required to transmit a specific number of qubits. For example, if the sender utilizes 10 qubits to transmit the session key needing 100 photons, and the transmission efficiency is 10%. In addition, the quantum security method 100 of the present disclosure has higher qubit efficiency than other existing quantum security methods. In one embodiment of the present disclosure, the qubit efficiency is defined as (session key bit length of the first single photon)/(qubit length of the first single photon sequence).

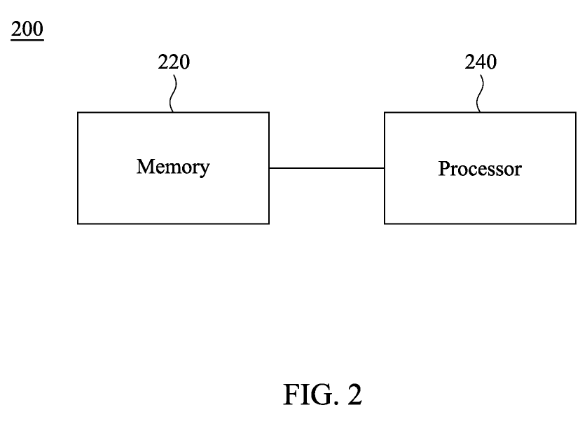

FIG. 2 is a functional block diagram of a quantum security system 200 in accordance with some embodiments of the present disclosure. The quantum security system 200 includes a memory 220 and a processor 240. The memory 220 is configured to store at least one instruction. The memory 220 may be a random access memory (RAM), static random-access memory (SRAM), a flash memory, a solid state drive (SSD), other similar components, or a combination of the above components, but is not limited to this. The processor 240 is coupled to the memory and configured to execute the at least one instruction to complete a plurality of steps: determining a session key by a sender and a receiver jointly; utilizing a hash function to process the session key to obtain a first string by the sender; combining the first string, a second string and a third string into a combined string by the sender; transmitting the combined string through at least one basis to generate a first single photon sequence by the sender, and transmitting the first single photon sequence to the receiver through a quantum channel by the sender; receiving the first single photon sequence and measuring the first string and the second string through the at least one basis to obtain a first return string and a second return string respectively by the receiver, and transmitting a second single photon sequence back to the sender by the receiver; verifying the first return string, the second return string and a third return string sequentially by the sender to obtain a first verification result; and utilizing the hash function to verify the session key to obtain a second verification result by the receiver. The processor 240 may be a central processing unit (CPU), a graphics processing unit (GPU), a microcontroller unit (MCU), a microprocessor, a system-on-chip (SoC), a digital signal processor (DSP), an application-specific integrated circuit (ASIC), a programmable logic controller (PLC), or a combination of the above components, but not limited to this.

In the quantum security system 200, detailed implementation of the processor 240 executing instructions stored in the memory 220 to complete a plurality of steps may refer to each step (including but not limited to Steps S110 to S170) shown in FIG. 1 in accordance with some embodiments of the present disclosure, which may not be described again here.

As can be seen from the above description, the quantum security method and the quantum security system in the present disclosure resists the collective attacks, the reflecting attacks and the impersonation attacks that may be encountered in the process of quantum communication by the implementation of selecting the basis for the sender to generate photons, selecting the basis for the receiver to measure photons, and mutual verification between the sender and the receiver, so as to achieve secure communication in a semi-quantum communication environment, and have higher transmission efficiency and qubit efficiency compared to other quantum security methods and quantum security systems.

It will be apparent to those skilled in the art that various modifications and variations can be made to the structure of the present disclosure without departing from the scope or spirit of this disclosure. In view of the foregoing, it is intended that the present disclosure cover modifications and variations of this disclosure provided they fall within the scope of the following claims.

What is claimed is:

1. A quantum security method, comprising:
determining a session key by a sender and a receiver jointly;
utilizing a hash function to process the session key to obtain a first string by the sender;
combining the first string, a second string and a third string into a combined string by the sender;
transmitting the combined string through at least one basis to generate a first single photon sequence by the sender, and transmitting the first single photon sequence to the receiver through a quantum channel by the sender;
receiving the first single photon sequence and measuring the first string and the second string through the at least one basis to obtain a first return string and a second return string respectively by the receiver, and transmitting a second single photon sequence back to the sender by the receiver;
verifying the first return string, the second return string and a third return string sequentially by the sender to obtain a first verification result; and
utilizing the hash function to verify the session key to obtain a second verification result by the receiver.

2. The quantum security method of claim 1, further comprising:
determining a first pre-shared key, a second pre-shared key and a third pre-shared key jointly by the sender and the receiver,
wherein the first pre-shared key and the second pre-shared key are utilized to determine positions of the first string, the second string and the third string in the combined string, and
wherein the third pre-shared key is utilized to determine the selected hash function.

3. The quantum security method of claim 1, wherein the at least one basis comprises a first basis and a second basis, and the first basis is a Z-basis, and the second basis is an X-basis.

4. The quantum security method of claim 3, wherein steps of transmitting the combined string through the at least one basis to generate the first single photon sequence by the sender comprising:
generating a first single photon through the first basis utilizing the first string;
generating a second single photon through the second basis utilizing the second string; and
generating a third single photon through the second basis utilizing the third string,
wherein the single photon sequence is composed of the first single photon, the second single photon and the third single photon.

5. The quantum security method of claim 4, wherein steps of receiving the first single photon sequence and measuring the first string and the second string through the at least one basis by the receiver comprises:
measuring the first single photon of the first string through the first basis; and
measuring the second single photon of the second string through the first basis,
wherein the receiver does not measure the third single photon of the third string but directly reflects the third single photon back to the sender.

6. The quantum security method of claim 1, wherein the sender verifies the first return string by comparing whether a content of the first return string is the same as a content of the first string,
wherein the sender verifies the second return string by comparing whether a content of the second return string is different from a content of the second string, and
wherein the sender verifies the third return string by comparing whether a content of the third return string is the same as a content of the third string.

7. The quantum security method of claim 6, wherein the sender obtains the first verification result of the sender verifying the receiver after the sender comparing the content of the first return string is the same as the content of the first string, comparing the content of the second return string is different from the content of the second string, and comparing the content of the third return string is the same as the content of the third string.

8. The quantum security method of claim 1, wherein the receiver obtains the second verification result of the receiver verifying the sender after the receiver verifying the session key utilizing the hash function.

9. A quantum security system, comprising:
a memory configured to store at least one instruction; and
a processor coupled to the memory and configured to execute the at least one instruction to complete a plurality of steps:
determining a session key by a sender and a receiver jointly;
utilizing a hash function to process the session key to obtain a first string by the sender;
combining the first string, a second string and a third string into a combined string by the sender;
transmitting the combined string through at least one basis to generate a first single photon sequence by the sender, and transmitting the first single photon sequence to the receiver through a quantum channel by the sender;
receiving the first single photon sequence and measuring the first string and the second string through the at least one basis to obtain a first return string and a second return string respectively by the receiver, and transmitting a second single photon sequence back to the sender by the receiver;
verifying the first return string, the second return string and a third return string sequentially by the sender to obtain a first verification result; and
utilizing the hash function to verify the session key to obtain a second verification result by the receiver.

10. The quantum security system of claim 9, wherein the sender is a quantum user utilizing a quantum device with full quantum capabilities, and the receiver is a traditional user utilizing a traditional device with limited quantum capabilities.
